(19) United States
(12) Patent Application Publication
(10) Pub. No.: US 2026/0083279 A1
(43) Pub. Date: Mar. 26, 2026

(54) AIR FRYER

(71) Applicant: GUANGZHOU QINGKUAI INNOVATION TECHNOLOGY CO., LTD., GUANGZHOU (CN)

(72) Inventor: QIFENG SONG, GUANGZHOU (CN)

(21) Appl. No.: 19/311,220

(22) Filed: Aug. 27, 2025

(30) Foreign Application Priority Data
Sep. 25, 2024 (CN) 202422351244.6
Sep. 29, 2024 (CN) 202422392605.1

(51) Int. Cl. A47J 37/06

(52) U.S. Cl. CPC A47J 37/0641

(57) ABSTRACT

An air fryer includes a main body, a food container, and a support mechanism. The main body includes outer surfaces and an internal cavity. The food container is detachably disposed in the internal cavity for holding food. The support mechanism is disposed on a rear surface of the main body. The support mechanism includes upper support portions and a lower support portion. The upper support portions are disposed on an upper end of the main body. The lower support portion is disposed on a lower end of the main body. The support mechanism is configured to support the main body, so that the air fryer is allowed to be placed vertically to reduce occupied space.

### TECHNICAL FIELD

The present disclosure relates to a technical field of air fryers, and in particular to an air fryer.

### BACKGROUND

A main body of an air fryer is generally designed to be a relatively wide structure. In addition, a handle of the air fryer makes the air fryer as a whole occupy a large space in a horizontal direction, making the air fryer inconvenient to store and carry.

### SUMMARY

The present disclosure provides an air fryer that is convenient to store and carry.

The air fryer comprises a main body, a food container, and a support mechanism.

The main body comprises outer surfaces and an internal cavity. A heating component and a fan component are disposed inside the internal cavity. The heating component is configured to heat air. The fan component is configured to blow the air to flow.

The food container is detachably disposed in the internal cavity to form an internal cooking space. The food container is removable from the internal cavity through a front surface of the main body.

The support mechanism is disposed on a rear surface of the main body. The support mechanism comprises upper support portions and a lower support portion. The upper support portions are disposed on an upper end of the main body. The lower support portion is disposed on a lower end of the main body.

The support mechanism is disposed on the rear surface of the main body. The support mechanism is configured to support the main body, so that the air fryer is allowed to be placed vertically. Compared to a case where the main body is placed horizontally, the air fryer placed vertically occupies less space, which improves the portability and versatility of the air fryer. The upper support portions and the lower support portion support the main body from the upper end and the lower end of the main body, thereby improving stability of the air fryer when being placed vertically.

Additional aspects and features of the present disclosure are given in part in the description below, and at least part of the present disclosure is made obvious from the description below or is indicated through practice of the present disclosure.

### BRIEF DESCRIPTION OF DRAWINGS

The above and/or additional aspects and features of the present disclosure will become obvious and easily understood from the description of the embodiments in conjunction with the following drawings.

FIG. 1 is a schematic diagram of an air dryer of the present disclosure.

FIG. 2 is a rear side schematic diagram of the air fryer shown in FIG. 1.

FIG. 3 is a schematic diagram of the air fryer shown in FIG. 1, where the air fryer is horizontally placed.

FIG. 4 is a schematic diagram of the air fryer shown in FIG. 3, where the air fryer is vertically placed.

FIG. 5 is another schematic diagram of the air fryer shown in FIG. 4, where the air fryer is vertically placed.

FIG. 6 is a schematic diagram of a hand-held mechanism and a food container of the present disclosure, where the hand-held mechanism is separated from the food container.

FIG. 7 is a cross-sectional schematic diagram of the hand-held mechanism and the food container of the present disclosure, where the hand-held mechanism is connected to the food container.

FIG. 8 is a cross-sectional schematic diagram of the hand-held mechanism and the food container of the present disclosure, where the hand-held mechanism is separated from the food container.

FIG. 9 is another schematic diagram of the air dryer embodiment of the present disclosure.

FIG. 10 is another schematic diagram of the air dryer of the present disclosure.

FIG. 11 is a schematic diagram of the air dryer of the present disclosure, where an outer shell thereof is removed.

FIG. 12 is a schematic diagram of a driver, a radiator, a hot-air-blowing fan, and a heating element of the present disclosure.

FIG. 13 is a schematic diagram of a ventilation plate of the present disclosure.

FIG. 14 is a schematic diagram of the driver and a main controller disposed on a top portion of a base of the present disclosure.

FIG. 15 is a cross-sectional schematic diagram of the air dryer of the present disclosure.

### DETAILED DESCRIPTION

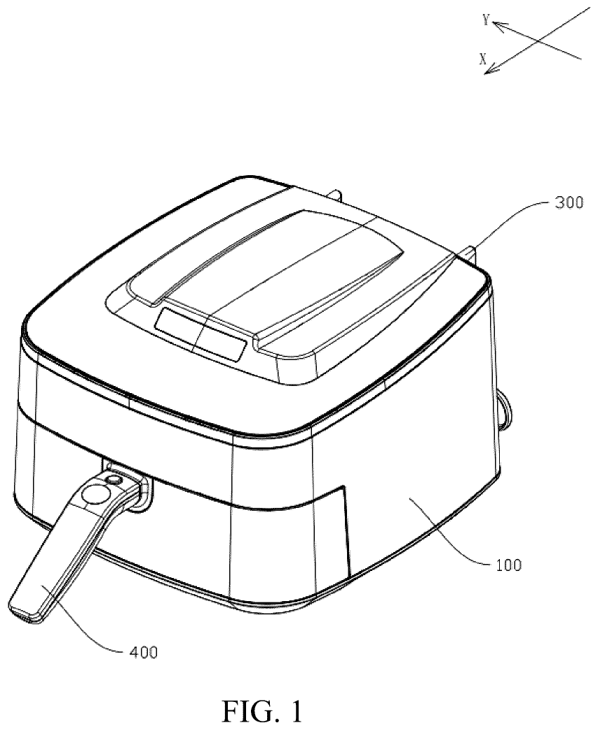

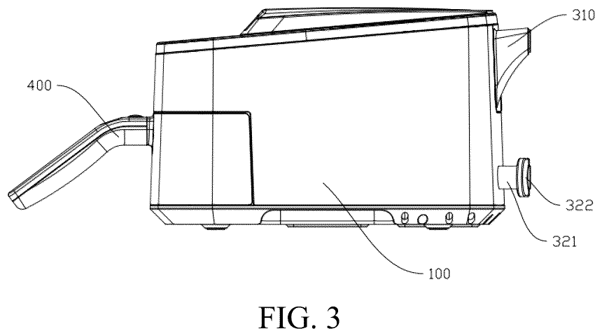

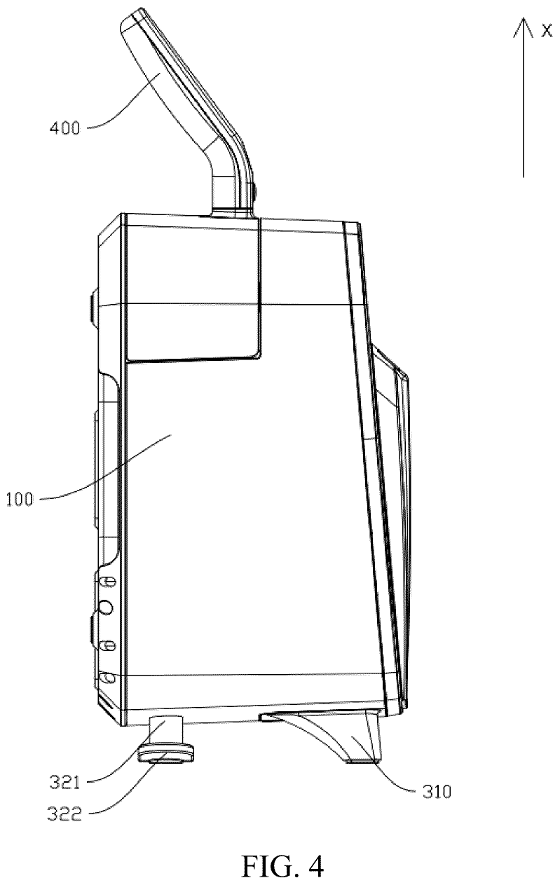

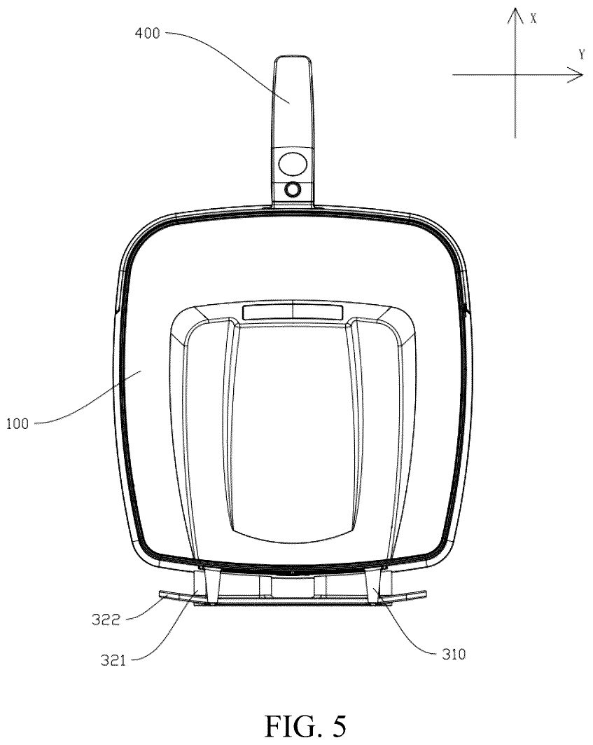

As shown in FIGS. 1-5, one embodiment of the present disclosure provides an air fryer.

As shown in FIGS. 1-5, the air fryer of one embodiment of the present disclosure comprises a main body 100, a food container 200, and a support mechanism 300. The main body 100 comprises outer surfaces and an internal cavity. A electric heating component is disposed inside the internal cavity. The electric heating component is configured to heat air in the internal cavity and transports heated air to the food container 200 to cook food. The food container 200 is detachably disposed in the internal cavity to form an internal cooking space. The food container 200 is configured to place food. The outer surfaces of the main body 100 comprise a front surface and a rear surface. Referring to directions shown in FIGS. 1-5, a direction of an X-axis is towards a front of the main body 100, and the direction opposite to the X-axis is towards a rear of the main body 100. A direction of a Y-axis in FIGS. 1-5 is toward a left of the main body 100, and a direction opposite to the Y-axis is toward a right of the main body 100. Thus, one side of the main body 100 close to the front is the front surface of the main body 100, and one side of the main body 100 away from the front surface is the rear surface of the main body 100. The food container 200 is removable from the internal cavity through the front surface of the main body 100, so that the food is allowed to be placed in or taken out of the air fryer.

The support mechanism 300 is disposed on the rear surface of the main body 100. The support mechanism 300 is configured to support the main body 100, so that the air fryer is allowed to be placed vertically. Compared to a case where the main body 100 is placed horizontally, the air fryer placed vertically occupies less space, which improves the portability and versatility of the air fryer.

The support mechanism 300 comprises upper support portions 310 and a lower support portion 320. The upper support portions 310 are disposed on an upper end of the main body 100. The lower support portion 320 is disposed on a lower end of the main body 100. The upper support portions 310 and the lower support portion 320 support the main body 100 from the upper end and the lower end of the main body 100, thereby improving stability of the air fryer when being placed vertically.

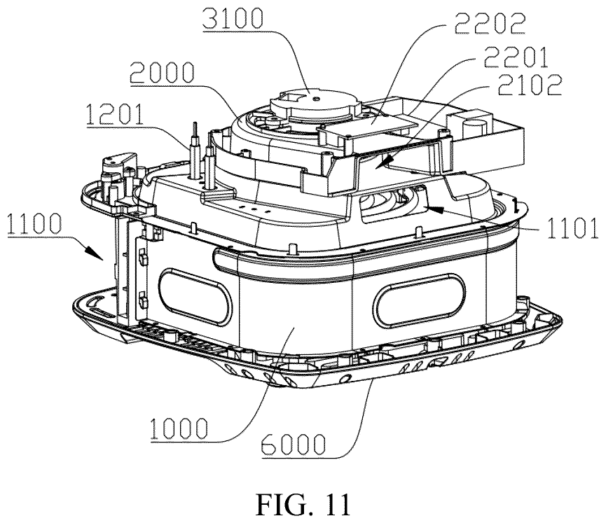

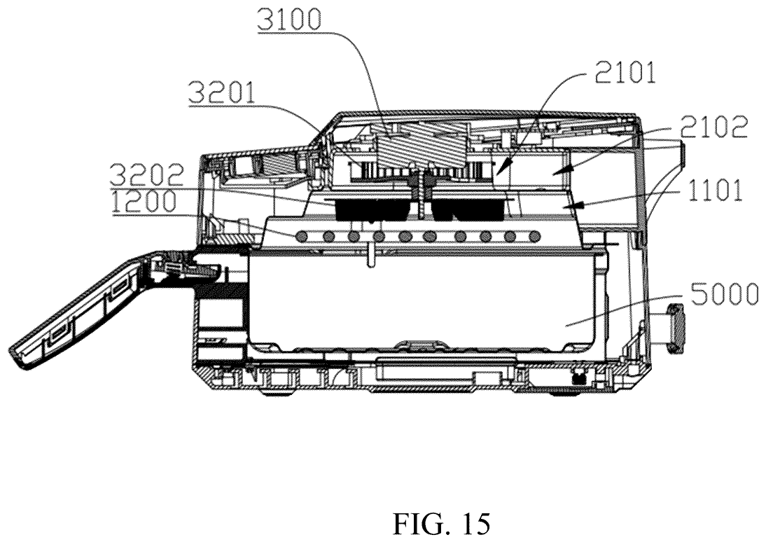

In some embodiments of the present disclosure, the electric heating component comprises a heating component and a fan component. The heating component is configured to heat the air, and the fan component is configured to blow the air to flow. The electric heating component is configured to heat the air and transport the heated air. Specifically, the electric heating component comprises the heating component and the fan component. The heating component heats the air, and the fan component drives hot air (i.e., the heated air) formed after heating, so that the heated air flows to a surface of the food in the food container 200 to heat the food, thereby completing cooking of the food. In conjunction with FIGS. 11, 12, 14 and 15, the heating component is a heating element 1200, and the fan component is a driver 3100 and a hot-air-blowing fan 3202. The heating element 1200, the driver 3100, and the hot-air-blowing fan 3202 are exemplarily described below.

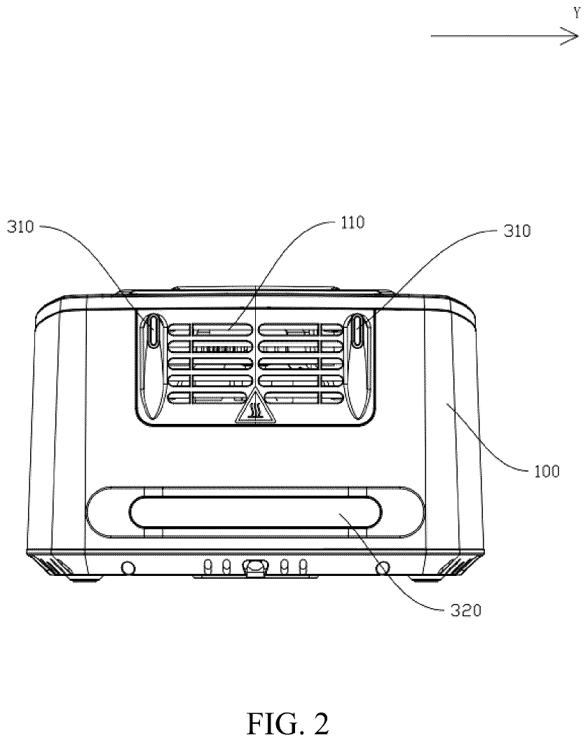

In some embodiments of the present disclosure, as shown in FIGS. 2-5, the rear surface of the main body 100 defines vent holes 110. The upper support portions 310 are disposed on two sides of the vent holes 110. The vent holes 110 are defined on the rear surface of the main body 100, and the hot air in the main body 100 is discharged through the vent holes 110. The upper support portions 310 are disposed on two sides of the vent holes 110. Specifically, in some embodiments, the upper support portions 310 comprise two support columns, and the two support columns are opposite to each other and are disposed on the two sides of the vent holes 110. The two support columns cooperate with the lower support portion 320 to form multi-point contact with a placement surface, so as to support the main body 100 from different positions. Therefore, the stability of the main body 100 is ensured when being placed vertically. It should be noted that by configuring the upper support portion 310 as the two support columns, the two support columns on the two sides of the vent holes 110 do not block the vent holes 110, which ensures the smooth discharge of the hot air. It is understood that the number and positions of the support columns may be adaptively modified according to needs. In some embodiments, four support columns are provided, and the four support columns are symmetrically disposed on the two sides of the vent holes 110, which is also within a protection scope of the present disclosure.

In some embodiments of the present disclosure, as shown in FIGS. 2-5, the lower support portion 320 comprises support feet 321 and a support plate 322. A winding storage space is defined between the support plate 322 and the support feet 321. The lower support portion 320 comprises the support feet 321 and the support plate 322. The support feet 321 are connected to the support plate 322. The support plate 322 is disposed on outer sides of the support feet 321 and is configured to abut against the placement surface. The support plate 322 is flat, which makes the main body 100 stable when being placed vertically. It is understood that in some embodiments, there are two support feet 321, and the two support feet 321 support the support plate 322 on two sides. A gap between the support feet 321 and the support plate 322 forms the winding storage space, which is configured to wind and store a wire such as a power cord or a charging cable. The winding storage space has good storage effect and improves portability of the air fryer. It is understood that in some embodiments, the upper support portions 310 and the lower support portion 320 are configured as support columns, and the wire is wound around the support columns, which also achieve the storage of the wire.

The air fryer according to another embodiment of the present disclosure is described below with reference to FIGS. 1-8.

As shown in FIGS. 1-8, the air fryer comprises a main body 100, a food container 200, a hand-held mechanism 400, and a support mechanism 300.

The main body 100 comprises outer surfaces and an internal cavity. An electric heating component is disposed inside the internal cavity. The food container 200 is detachably disposed in the internal cavity to form an internal cooking space. The food container 200 is configured to place food. The food container 200 is removable from the internal cavity through the front surface of the main body 100, so that the food is allowed to be placed in or taken out of the air fryer. The electric heating component is configured to heat air in the internal cavity and transports heated air to the food container 200 to cook food. The hand-held mechanism 400 is detachably mounted on the food container 200, and the hand-held mechanism 400 is allowed to be detached from or mounted on the food container 200 when the food container 200 is held in the internal cavity, which is convenient to mount and detach. When storing, the hand-held mechanism 400 is disassembled, and a space occupied by the air fryer as a whole is reduced regardless of whether it is placed horizontally or vertically.

The support mechanism 300 is disposed on a rear surface of the main body 100, and the support mechanism 300 is configured to support the main body 100, so that the air fryer is allowed to be vertically placed. Compared to the case where the main body 100 is placed horizontally, the air fryer placed vertically with the hand-held mechanism 400 thereof being detached occupies less space, which improves the portability and versatility of the air fryer. The support mechanism 300 comprises upper support portions 310 and a lower support portion 320. The upper support portions 310 are disposed on an upper end of the main body 100. The lower support portion 320 is disposed on a lower end of the main body 100. The upper support portions 310 and the lower support portion 320 support the main body 100 from the upper end and the lower end of the main body 100, thereby improving the stability of the air fryer when being placed vertically.

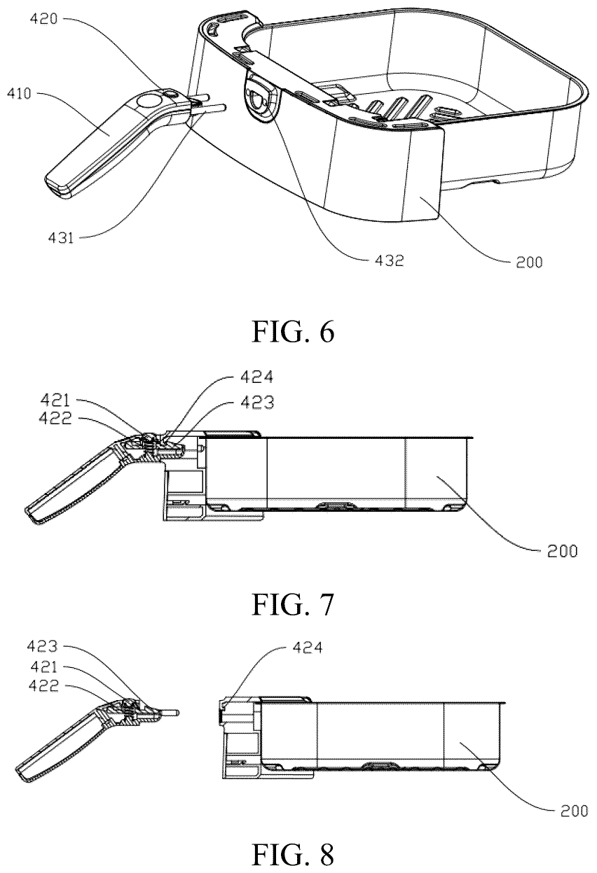

In some embodiments of the present disclosure, as shown in FIGS. 6-8 the hand-held mechanism 400 comprises a gripping portion 410 and a plugging portion 420. The gripping portion 410 is connected to the plugging portion 420. The plugging portion 420 is configured to be detachably mounted on the food container 200. The hand-held mechanism 400 facilitates the taking and placing of the food container 200. Specifically, the hand-held mechanism 400 comprises the gripping portion 410 and the plugging portion 420. The gripping portion 410 is configured to be held by a human hand, and the plugging portion 420 is configured to be connected to the main body 100 to achieve detachable installation of the hand-held mechanism 400 and the food container 200. It is understood that in some embodiments, the gripping portion 410 and the plugging portion 420 are configured as an integrated structure.

In some embodiments of the present disclosure, as shown in FIGS. 7-8, the plugging portion 420 comprises a buckle 423. The food container 200 comprises a buckling groove 424. The buckle 423 is detachably buckled with the buckling groove 424, so that the plugging portion 420 is detachably connected to the food container 200. The plugging portion 420 is configured to be detachably connected to the food container 200. The plugging portion 420 comprises the buckle 423. The food container 200 comprises the buckling groove 424. The buckle 423 is detachably buckled with the buckling groove 424, so as to realize a detachable connection between the plugging portion 420 and the food container 200. A connection therebetween is made easy by the buckling groove 424 and the buckle 423. It is understood that in some other embodiments, the plugging portion 420 and the food container 200 are detachably connected by a threaded connection.

In some embodiments of the present disclosure, as shown in FIGS. 7-8, the plugging portion 420 further comprises a pressing portion 421 and an elastic piece 422. The pressing portion 421 and the elastic piece 422 are configured to control the buckle 423. The plugging portion 420 comprises the pressing portion 421 and the elastic piece 422. The pressing portion 421 is configured to press the buckle 423, and the elastic piece 422 is configured to drive the buckle 423 to rebound, thereby realizing the pressing and rebounding of the buckle 423, making it easy to assemble the buckle 423 into the buckling groove 424, and realizing a detachable connection between the plugging portion 420 and the food container 200. Specifically, in some embodiments, the plugging portion 420 defines a chamber, and the buckle 423 is disposed in the chamber. The elastic piece 422 is disposed between the buckle 423 and an inner wall of the chamber, and the pressing portion 421 is disposed above the buckle 423. The buckle 423 and the elastic piece 422 are disposed in the chamber. The pressing portion 421, the buckle 423, and the elastic piece 422 are disposed on a same axis. The elastic piece 422 is disposed between the buckle 423 and the inner wall of the chamber. The pressing portion 421 presses the buckle 423 to move, so that the buckle 423 is pressed down to enter the buckling groove 424. After the buckle 423 enters the buckling groove 424, the buckle 423 rebounds upward under an action of the elastic piece 422, so that the buckle 423 is buckled with the buckling groove 424 to achieve assembly and fixation of the hand-held mechanism.

. In some embodiments of the present disclosure, as shown in FIGS. 6-8, the hand-held mechanism 400 comprises first positioning components 431, the food container 200 comprises second positioning components 432, and the first positioning components 431 are matched with the second positioning components 432 to achieve positioning and mounting between the hand-held mechanism 400 and the food container 200. The hand-held mechanism 400 is detachably connected to the food container 200. The hand-held mechanism 400 comprises the first positioning components 431, and the food container 200 comprises the second positioning components 432. When the hand-held mechanism 400 is assembled with the food container 200, the first positioning components 431 of the hand-held mechanism 400 are respectively connected to the second positioning components 432 of the food container 200, so that the hand-held mechanism 400 is stably mounted on the food container 200. In some embodiments, the first positioning components 431 are configured as positioning posts, and the second positioning components 432 are configured as positioning holes. By plugging the positioning posts respectively into the positioning holes, not only is the hand-held mechanism 400 positioned during assembly, but a connection strength between the hand-held mechanism 400 and the food container 200 is improved. It is understood that in other embodiments, the first positioning components 431 are configured as the positioning holes, and the second positioning components 432 are configured as the positioning posts, which also achieve stable connection between the hand-held mechanism 400 and the food container 200. It should be noted that, in some embodiments, two first positioning components 431 are provided, and the two first positioning components 431 are disposed opposite to each other. The number and positions of the second positioning components 432 correspond to the number and positions of the first positioning components 431, which improves the positioning effect and connection strength.

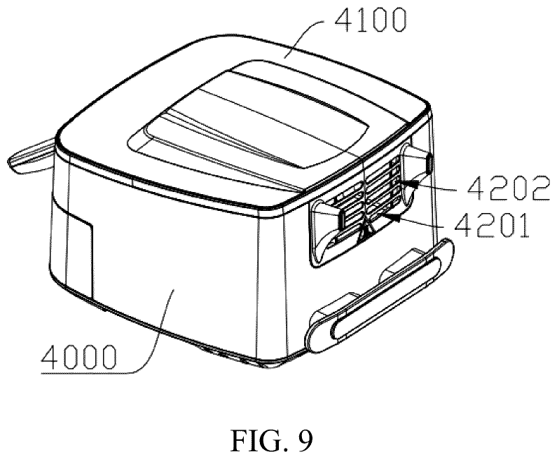

The air fryer shown in FIGS. 1-8 further comprises a main controller and an integrated chip. Specific reference may be made to the main controller 2201 and the integrated chip 2202 shown in FIGS. 9-15, which is described below.

The air fryer shown in FIGS. 1-8 further comprises a radiator. Specific reference may be made to the radiator 3201 shown in FIGS. 9-15, which is described below.

The following describes another embodiment of an air fryer according to the present disclosure with reference to FIGS. 9-15.

As shown in FIGS. 9-15, the air fryer comprises a base 1000, an outer shell 4000, and an inner shell 2000. The inner shell 2000 is disposed on a top portion of the base 1000. The base 1000 is disposed in the outer shell 4000. The outer shell is sleeved on the base 1000. Furthermore, an electronic device chamber is formed between the top portion of the base 1000 and a top portion of the outer shell 4000, and the inner shell 2000 is disposed in the electronic device chamber. For instance, the air fryer further comprises a top cover 4100. The top cover 4100 is disposed on the top portion of the outer shell 4000 to cover the top portion of the outer shell 4000.

The air fryer comprises an electric heating component. The base 1000 defines a heating chamber 1100. The electric heating component is disposed on a top portion of the heating chamber 1100 to create a high temperature environment for the heating chamber 1100. Specifically, the electric heating component comprises a heating element 1200. The heating element is configured as a resistance heating tube. The heating element 1200 is formed along a spiral curve and is formed into a disc shape.

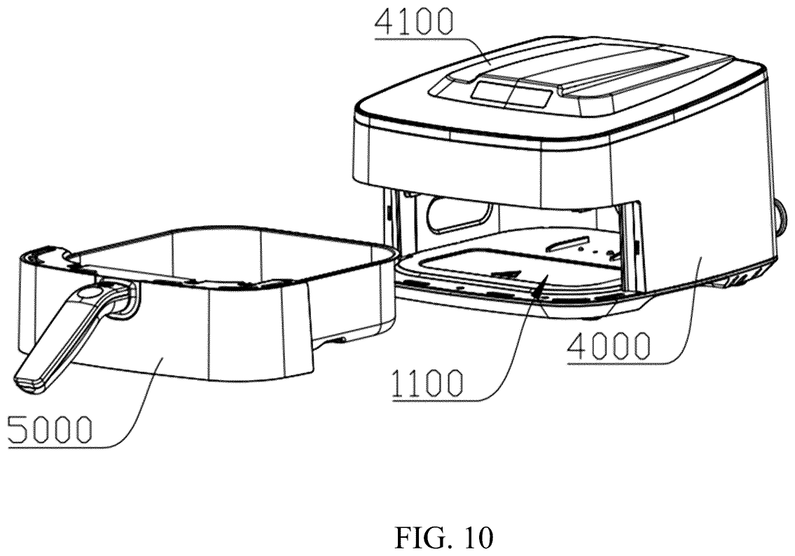

As shown in FIG. 10, the air fryer comprises a food container 5000. The food container 5000 is configured as a tray or drawer. The food container 5000 is placed in the heating chamber 1100 for high-temperature processing. Furthermore, the heating chamber 1100 has an opening on a front side of the outer shell 4000, allowing the food container 5000 to be placed into the heating chamber 1100 from the front side of the outer shell 4000. The food container 5000 further comprises a handle.

As shown in FIG. 10, the air fryer comprises a main controller 2201. The main controller 2201 is mounted in the inner shell 2000. Specifically, the main controller 2201 is fixed to a surface of the inner shell 2000 and is connected to a visual panel disposed on one of outer surfaces of the air fryer. The user is allowed to operate the visual panel to set parameters or modes of the air dryer. The main controller 2201 is connected to the heating element via conductive wires, so that the user is allowed to operate the heating element through the main controller 2201.

It should be noted that wiring terminals 1201 of the heating element are disposed at the top portion of the base 1000. The wiring terminals 1201 and the main controller are respectively located on a left side and a right side of the top portion of the base 1000. Considering that the wiring terminals 1201 need to be connected to the conductive wires, in order to avoid the wiring terminals 1201 and the main controller 2201 being located on the same side and increasing the space occupied by the wiring terminals 1201 and the main controller 2201 in the air fryer, the present disclosure specially disposes the wiring terminals 1201 and the main controller 2201 on the left side and the right side of the base to improve space utilization.

The air fryer comprises a driver 3100 and the radiator 3201. The driver 3100 is fixedly disposed in the inner shell 2000. The radiator 3201 is disposed in the inner shell 2000 and is fixedly connected to a rotating shaft of the driver 3100. The inner shell 2000 defines a first chamber 2101, and the radiator 3201 is disposed in the first chamber 2101.

The driver 3100 drives the radiator 3201 to rotate, creating a cooling airflow that lowers a temperature in the inner shell 2000 of the air fryer. It is understood that the heating chamber 1100 is a separate chamber within the air fryer. Considering high heat generated by the heating chamber 1100 and to prevent damage to components within the electronic device chamber, the air fryer is equipped with the radiator 3201 to dissipate heat generated by components within the outer shell 4000.

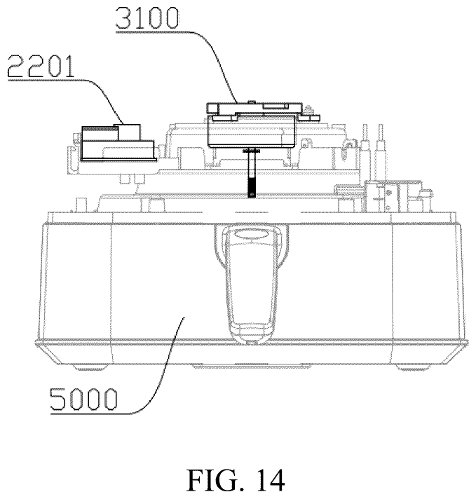

The wiring terminals 1201 and the main controller 2201 are respectively located on a left side and a right side of the driver 3100 to improve space utilization. Furthermore, as shown in FIG. 14, a highest point of the main controller 2201 within the inner shell 2000 is lower than a highest point of the driver 3100 within the inner shell 2000.

As shown in FIGS. 11, 14, and 15, the driver 3100 is disposed in a middle of the top portion of the base 1000, so that the driver 3100 is disposed in a middle of the electronic device chamber. In this case, the wiring terminals 1201 and the main controller 2201 are located on the left side and the right side of the driver 3100, which effectively reduces an occupied space.

In one embodiment, the air fryer further comprises an integrated chip 2202. The integrated chip 2202 is fixedly disposed on a surface of the inner shell 2000.

The integrated chip 2202 is connected to the main controller 2201 via the conductive wires. The integrated chip 2202 comprises a circuit board connected to the driver 3100.

Since the driver 3100 requires a separate circuit board, if the integrated chip 2202 and main controller 2201 share the same circuit board, space requirements increase. Therefore, to reduce space in the air fryer and optimize a shape of the inner shell 2000, the main controller 2201 and the integrated chip 2202 are positioned at different locations on the surface of the inner shell 2000, adapting their placement to the shape of the inner shell 2000.

The main controller 2201 and the integrated chip 2202 are located on different sides of the inner shell 2000, effectively utilizing a surface area of the inner shell 2000 and avoiding increasing a size of the inner shell 2000. Considering that the main controller 2201 has a large size and occupies a significant surface area on the inner shell 2000, the integrated chip 2202 is located on another side of the inner shell 2000, away from the main controller 2201, thereby avoiding increasing the size of the inner shell 2000 to accommodate the integrated chip 2202.

Furthermore, the integrated chip 2202 is located on the same side as the wiring terminals 1201, or the integrated chip 2202 is disposed on the surface of the inner shell 2000 and behind the driver 3100.

In some embodiments, a height of the air fryer is not greater than 200 mm. A width of the air fryer is not greater than 320 mm.

As shown in FIGS. 1-5, a height direction of the air fryer is defined as a direction perpendicular to the X-axis and the Y-axis, and a width direction of the air fryer is defined as a direction in the direction of the Y-axis or the direction opposite to the Y-axis. The height of the air fryer is not greater than 200, which means that the height of the air fryer along the height direction does not exceed 200 mm. The width of air fryer is not greater than 320 mm, which means that the width of air fryer along the width direction does not exceed 320 mm.

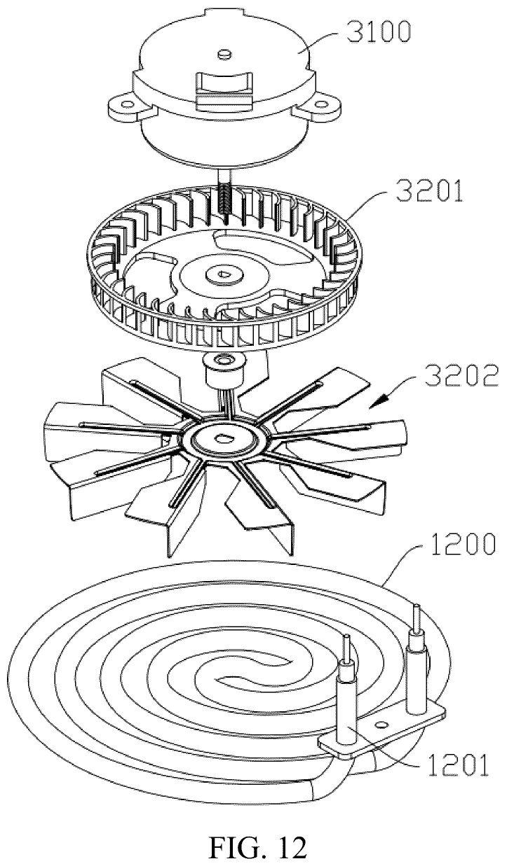

In one embodiment, as shown in FIG. 12, the air fryer further comprises a hot-air-blowing fan 3202. The hot-air-blowing fan 3202 is fixedly connected to the rotating shaft of the driver 3100. The hot-air-blowing fan 3202 is disposed in the heating chamber 1100, and the hot-air-blowing fan 3202 is disposed on an upper side of the heating element 1200.

Driven by the hot-air-blowing fan 3202, a circulating airflow forms in the heating chamber 1100. The circulating airflow in the heating chamber 1100 flows from top to bottom through the electric heating component, and the electric heating component heats the circulating airflow. Meanwhile, heated airflow flows from top to bottom, toward the surface of the food in the food container 5000, so as to heat the food.

It should be noted that the radiator 3201 and the hot-air-blowing fan 3202 share the same rotating shaft of the driver 3100. The driver 3100 drives the radiator 3201 and the hot-air-blowing fan 3202 simultaneously, ensuring a compact structure of the air fryer and improving efficiency.

Furthermore, the driver 3100 comprises a direct-current (DC) motor. The driver 3100 of the present disclosure is not a conventional alternating current (AC) motor, but the DC motor. The DC motor has a smaller size and a smaller height than the AC motor, which facilitates the compact structure of the air fryer. Therefore, the air fryer is smaller and shorter than a conventional air fryer, which improves portability.

It is understood that the hot-air-blowing fan 3202 is disposed in the heating chamber 1100, and the inner shell 2000 defines the first chamber 2101 for accommodating the radiator 3201, which helps to reduce the space occupied by the rotating shaft of the driver 3100 in the air fryer, thereby reducing the height of the air fryer.

In one embodiment, a rear sidewall of the outer shell 4000 defines air outlets 4201 and air inlets 4202. Cold air is allowed to enter the air fryer from the air inlets 4202 under an action of the radiator, and is then discharged from the air outlets 4201.

As shown in FIG. 9, the rear sidewall of the outer shell 4000 defines the air inlets 4202 and the air outlets 4201 to maintain the integrity of remaining sidewalls of the outer shell 4000, ensuring the integrity and aesthetics of the air fryer. The cold air is able to enter the air inlets.

Furthermore, as shown in FIG. 11, the rear sidewall of the first chamber 2101 defines a first passage 2102 connected to the exhaust port 4201. The cold air entering the outer shell 4000 enters the first chamber 2101 from the top portion thereof and flows from the rear side of the first chamber 2101 to the air outlets 4201. The rear sidewall of the heating chamber 1100 defines a second passage 1101 communicated with the air outlets 4201.

Considering the heat generated by the circuit board of the integrated chip 2202, the integrated chip 2202 is disposed close to the air inlets 4202 on the rear sidewall of the outer shell 4000. The cold air reduces the temperature of the integrated chip 2202.

To enhance heat dissipation performance of the air fryer, at least one air inlet hole is defined on a bottom portion of the air fryer. Specifically, the air fryer comprises a bottom seat 6000, the base 1000 is mounted on the bottom seat 6000, and the outer shell 4000 is fixedly connected to the bottom seat 6000. The bottom seat 6000 comprises at least one air inlet hole.

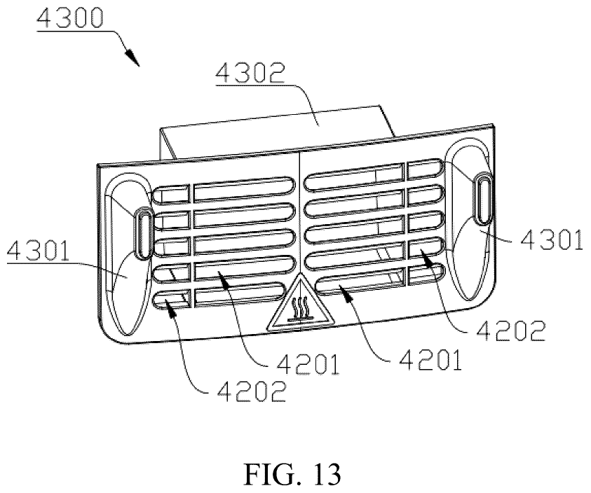

In one embodiment, as shown in FIG. 13, the air fryer further comprises a ventilation plate 4300. The ventilation plate 4300 is disposed on the rear sidewall of the outer shell 4000. The air outlets 4201 and the air inlets 4202 on the rear sidewall of the outer shell 4000 are defined on the ventilation plate 4300, and the air inlets 4202 are respectively disposed on a left side and a right side of the air outlets 4201 of the ventilation plate 4300. The rear sidewall of the outer shell 4000 defines a window, and the ventilation plate 4300 is mounted in the window.

A communicating structure 4302 that is hollow is disposed on an inner side of the ventilation plate 4300. The communicating structure 4302 extends from the inner side of the ventilation plate 4300 toward the base 1000. Both the first passage 2102 and the second passage 1101 are communicated with the communicating structure 4302, so that the heating chamber 1100 and the first chamber 2101 are communicated with the air outlets 4201. Furthermore, the communicating structure 4302 is configured as a rectangular tube.

It is understood that the ventilation plate 4300 is made from a heat-resistant material.

In some embodiments, the ventilation plate 4300 comprises grids, where central grids are served as the air outlets 4201 and grids on two sides thereof are served as the air inlets 4202.

In one embodiment, in order to make the air fryer convenient to store and carry, the air fryer is placed upright. The air dryer further comprises support structures. At least part of the support structures are disposed on the rear sidewall of the outer shell 4000, and the air fryer is placed upright through the support structures.

In this case, support stands 4301 are disposed on the rear sidewall of the outer shell 4000 to support the rear side of the air fryer. It is understood that the upright placement of the air fryer is understood as the vertical placement of the air fryer. It is understood that the support stands 4301 of the outer shell 4000 are the upper support portions 310 in the embodiments related to FIGS. 1-8.

Furthermore, as shown in FIG. 13, at least two of the support structures are disposed on an outer surface of the ventilation plate 4300. When the air dryer is vertically placed, the support structures support the rear sidewall of the outer shell 4000. Specifically, the support stands 4301 are respectively disposed on the left side and the right side of the ventilation plate 4300.

To enhance the stability of the air fryer when placed upright, a detachable support structure is disposed on the rear sidewall of the outer shell 4000. In actual use, the power cord of the air dryer is wrapped around the detachable support structure on the rear sidewall of the outer shell 4000 for convenient storage. It is understood that the detachable support structure on the outer shell 4000 is understood as the lower support portion 320 of the embodiments related to FIGS. 1-8. The support structures on the ventilation plate 4300, such as the support stands 4301, and the detachable support structure on the rear sidewall of the outer shell 4000 may refer to the upper support portions 310 and lower support portion 320 in FIGS. 1-8, which are not repeatedly described herein.

In the related art, the air outlets are defined on the ventilation plate, the air inlets are defined on the outer shell, and the window is defined on the rear sidewall of the outer shell for mounting the ventilation plate. However, in order to dispose the support stands 4301 of the air fryer in this application, the support stands 4301 need to be disposed on the rear side of the air fryer. To reduce the processing of the outer shell 4000, the support stands 4301 are specially disposed on the outer side of the ventilation plate 4300. Moreover, the air inlets 4202 on the rear sidewall of the outer shell 4000 are defined on the ventilation plate 4300, thereby further reducing the processing difficulty of the outer shell 4000.

In one embodiment, the base 1000, the inner shell 2000, the outer shell 4000, the top cover 4100, the ventilation plate 4300, and bottom seat 6000 of the air fryer shown in FIGS. 9-15 are understood as the main body 100 of the air fryer shown in FIGS. 1-8. That is, in an alternative embodiment, the main body 100 of the air fryer shown in FIGS. 1-8 comprises the base 1000, the inner shell 2000, the outer shell 4000, the top cover 4100, the ventilation plate 4300, and the bottom seat 6000 of the air fryer shown in FIGS. 9-15. It should be noted that the main body 100 of the air fryer shown in FIGS. 1-8 is not limited to comprise the base 1000, the inner shell 2000, the outer shell 4000, the top cover 4100, the ventilation plate 4300, and the bottom seat 6000 of the air fryer shown in FIGS. 9-15.

What is claimed is:

1. An air fryer, comprising:
a main body;
a food container; and
a support mechanism;
wherein the main body comprises outer surfaces and an internal cavity, a heating component and a fan component are disposed inside the internal cavity, the heating component is configured to heat air, and the fan component is configured to blow the air to flow;
wherein the food container is detachably disposed in the internal cavity to form an internal cooking space, and the food container is removable from the internal cavity from a front surface of the main body;
wherein the support mechanism is disposed on a rear surface of the main body, the support mechanism comprises upper support portions and a lower support portion, the upper support portions are disposed on an upper end of the main body, and the lower support portion is disposed on a lower end of the main body.

2. The air fryer according to claim 1, wherein the rear surface of the main body defines vent holes, and the upper support portions are disposed on two sides of the vent holes.

3. The air fryer according to claim 1, wherein the lower support portion comprises support feet and a support plate, and a winding storage space is defined between the support plate and the support feet.

4. An air fryer, comprising:
a main body;
a food container;
a hand-held mechanism; and
a support mechanism;
wherein the main body comprises outer surfaces and an internal cavity, a heating component and a fan component are disposed inside the internal cavity, the heating component is configured to heat air, and the fan component is configured to blow the air to flow;
wherein the food container is detachably disposed in the internal cavity to form an internal cooking space, and the food container is removable from the internal cavity from a front surface of the main body;
wherein the hand-held mechanism is detachably mounted on the food container, and the hand-held mechanism is allowed to be detached or mounted on the food container when the food container is held in the internal cavity;
wherein the support mechanism is configured to vertically support the main body, and the support mechanism is disposed on a rear surface of the main body.

5. The air fryer according to claim 4, wherein the hand-held mechanism comprises at least one first positioning component, the food container comprises at least one second positioning component, and the at least one first positioning component is matched with the at least one second positioning component, so that the hand-held mechanism is allowed to be positioned and mounted on the food container.

6. The air fryer according to claim 4, wherein the hand-held mechanism comprises a gripping portion and a plugging portion, the gripping portion is connected to the plugging portion, and the plugging portion is configured to be detachably mounted on the food container.

7. The air fryer according to claim 6, wherein the plugging portion comprises a buckle, the food container comprises a buckling groove, and the buckle is detachably buckled with the buckling groove, so that the plugging portion is detachably connected to the food container.

8. The air fryer according to claim 7, wherein the plugging portion further comprises a pressing portion and an elastic piece, the pressing portion and the elastic piece are configured to control the buckle, the plugging portion defines a chamber, the buckle is disposed in the chamber, the elastic piece is disposed between the buckle and an inner wall of the chamber, and the pressing portion is disposed above the buckle.

9. The air fryer according to claim 4, wherein the support mechanism comprises upper support portions and a lower support portion, the upper support portions are disposed on an upper end of the main body, the lower support portion is disposed on a lower end of the main body, the rear surface of the main body defines vent holes, and the upper support portions are disposed on two sides of the vent holes.

10. The air fryer according to claim 4, wherein the support mechanism comprises upper support portions and a lower support portion, the upper support portions are disposed on an upper end of the main body, the lower support portion is disposed on a lower end of the main body, the lower support portion comprises support feet and a support plate, and a winding storage space is defined between the support plate and the support feet.

11. An air fryer, comprising:
a base;
an outer shell;
an inner shell;
a main controller;
a driver;
a radiator;
a heating element; and
support structures;
wherein the base defines a heating chamber, the base is disposed in the outer shell, the inner shell is disposed on a top portion of the base, the main controller is disposed on the inner shell, the driver is fixedly disposed on the inner shell, and the radiator is fixedly connected to a rotating shaft of the driver;
wherein the heating element is disposed in the heating chamber, wiring terminals of the heating element are disposed at the top portion of the base, and the wiring terminals and the main controller are respectively located on a left side and a right side of the driver;
wherein the support structures are disposed on a rear sidewall of the outer shell, and the air fryer is vertically placed through the support structures.

12. The air fryer according to claim 11, wherein a highest point of the main controller in the inner shell is lower than a highest point of the driver in the inner shell.

13. The air fryer according to claim 11, wherein the air fryer further comprises an integrated chip, and the main controller and the integrated chip are disposed at different positions on a surface of the inner shell.

14. The air fryer according to claim 13, wherein the integrated chip and the wiring terminals are located on a same side of the air fryer, or the integrated chip is disposed on the surface of the inner shell and is disposed at a rear side of the driver.

15. The air fryer according to claim 11, wherein the rear sidewall of the outer shell defines air outlets and air inlets, cold air is allowed to enter the air fryer from the air inlets, and the integrated chip is close to the air inlets on the rear sidewall of the outer shell.

16. The air fryer according to claim 15, wherein the air fryer further comprises a ventilation plate, the ventilation plate is disposed on the rear sidewall of the outer shell, the air outlets and the air inlets on the rear sidewall of the outer shell are defined on the ventilation plate, and the air inlets are respectively disposed on a left side and a right side of the air outlets of the ventilation plate.

17. The air fryer according to claim 11, wherein the air fryer further comprises a hot-air-blowing fan, the hot-air-blowing fan is fixedly connected to the rotating shaft of the driver, the hot-air-blowing fan is disposed in the heating chamber, and the hot-air-blowing fan is disposed on an upper side of the heating element.

18. The air fryer according to claim 11, wherein the driver is disposed in a middle of the top portion of the base.

19. The air fryer according to claim 11, wherein a height of the air fryer is not greater than 200 mm, and a width of the air fryer is not greater than 320 mm.

20. The air fryer according to claim 11, wherein the air fryer further comprises a ventilation plate, the ventilation plate is disposed on the rear sidewall of the outer shell, air outlets are defined on the ventilation plate, and air inlets are respectively disposed on a left side and a right side of the air outlets;
wherein at least two of the support structures are disposed on an outer surface of the ventilation plate, and a detachable support structure of the support structures is disposed on the rear sidewall of the outer shell.
